(19) United States
(12) Patent Application Publication
(10) Pub. No.: US 2026/0320612 A1
(43) Pub. Date: Oct. 15, 2026

(54) SYSTEMS AND METHODS FOR DETECTING UNAUTHORIZED APPROPRIATION ATTEMPTS USING MODELING LIGHT TRANSPORT TECHNIQUES

(71) Applicant: BANK OF AMERICA CORPORATION, Charlotte, NC (US)

(72) Inventors: Saurabh Arora, Gurugram (IN); Sandeep Kumar Chauhan, Miyapur (IN); Maneesh Kumar Sethia, Hyderabad (IN)

(73) Assignee: BANK OF AMERICA CORPORATION, Charlotte, NC (US)

(21) Appl. No.: 19/174,762

(22) Filed: Apr. 9, 2025

(51) Int. Cl. G06Q 20/40; G06Q 20/42; G06T 5/20; G06T 5/70; G06T 15/06; G06V 10/75

(52) U.S. Cl. CPC G06Q 20/4016; G06Q 20/42; G06T 5/20; G06T 5/70; G06T 15/06; G06V 10/751

(57) ABSTRACT

Systems, computer program products, and methods are described herein for detecting unauthorized appropriation attempts using modeling light transport techniques. The present disclosure is configured to receive a transaction request and retrieve a template pattern based on a geolocation of the transaction request. The template pattern may include one or more light patterns used to identify an entity. A ray casting process may be triggered while the template pattern is retrieved. The ray casting process captures object information, extracts ambient objects, applies a filter, and extracts details associated with the ambient objects. The extracted details and the template pattern are compared.

### TECHNOLOGICAL FIELD

Example embodiments of the present disclosure relate to systems and methods for detecting unauthorized appropriation attempts using modeling light transport techniques.

### BACKGROUND

There are significant issues associated with determining the legitimacy of transaction attempts. Applicant has identified a number of deficiencies and problems associated with conventional procedures for detecting unauthorized transactions. Through applied effort, ingenuity, and innovation, many of these identified problems have been solved by developing solutions that are included in embodiments of the present disclosure, many examples of which are described in detail herein.

### BRIEF SUMMARY

The following presents a simplified summary of one or more embodiments of the present disclosure, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

Systems, methods, and computer program products are provided for detecting unauthorized appropriation attempts using modeling light transport techniques.

Embodiments of the present invention address the above needs and/or achieve other advantages by providing apparatuses (e.g., a system, computer program product, and/or other devices) and methods for detecting unauthorized appropriation attempts using modeling light transport techniques. The system embodiments may comprise a processing device and a non-transitory storage device containing instructions when executed by the processing device, to perform the steps disclosed herein. In computer program product embodiments of the invention, the computer program product comprises a non-transitory computer-readable medium comprising code causing an apparatus to perform the steps disclosed herein. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the steps disclosed herein.

In some embodiments, the present disclosure provides a solution that may receive, from a third-party device, a transaction request including a resource container associated with a user. In some embodiments, the solution may retrieve a template pattern based on a geolocation of the transaction request, the template pattern comprising one or more light patterns used to identify an entity associated with the transaction request. In some embodiments, the present solution may, while retrieving the template pattern, trigger a ray casting process executed by a user device associated with the user. In some embodiments, the ray casting process may include capturing, via a camera associated with the user device, object information of the user's physical surroundings. In some embodiments, the ray casting process may include extracting ambient objects captured from the user device. In some embodiments, the ray casting process may include projecting the ambient objects on an image plane. In some embodiments, the ray casting process may include applying a filter to the ambient objects on the image plane for enhancing image quality. In some embodiments, the ray casting process may include extracting details associated with the ambient objects. In some embodiments, the solution may compare the template pattern and the extracted details associated with the ambient objects. In some embodiments, the solution may determine the transaction request is an unauthorized appropriation attempt initiated by a malicious individual. In some embodiments, the solution may reject the transaction request.

In some embodiments, the solution may generate a notification including an alert interface component configured to notify the user about the transaction request. In some embodiments, the solution may transmit the notification to the user device.

In some embodiments, the notification may include generating, based on the object information captured from the camera associated with the user device, a prompt requesting the user to position the camera associated with the user device in a specific orientation to match the template pattern.

In some embodiments, the prompt may include displaying an overlay image on a graphical user interface associated with the user device configured to prompt the user to orient the camera associated with the user device at a specific object.

In some embodiments, the determination that the transaction request is the unauthorized appropriation attempt initiated by the malicious individual is performed locally on the user device prior to the transaction request being transmitted to other stakeholders.

In some embodiments, the template pattern is retrieved from a database associated with the entity.

In some embodiments, the solution may retrieve a customer template pattern including previously captured customer patterns. In some embodiments, the solution may compare the customer template pattern and the extracted details associated with the ambient objects.

In some embodiments, the ray casting process may include generating, by the user device, a plurality of virtual rays originating from the user device positioned within a three-dimensional representation of an environment of the user. In some embodiments, the ray casting process may include tracing each virtual ray through the three-dimensional representation to detect a plurality of intersections with the ambient objects within the environment. In some embodiments, the ray casting process may include determining surface properties at each of the plurality of intersections. In some embodiments, the ray casting process may include aggregating intersection data to form a spatial map of the environment. In some embodiments, the ray casting process may include generating the image plane based on the aggregated intersection data representing the surface properties of the ambient objects.

In some embodiments, applying the filter to the ambient objects on the image plane comprises performing a de-noising operation that reduces image artifacts by removing noise while preserving details of the ambient objects.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for detecting unauthorized appropriation attempts using modeling light transport techniques, in accordance with an embodiment of the disclosure;

FIG. 2 illustrates a process flow for detecting unauthorized appropriation attempts using modeling light transport techniques, in accordance with an embodiment of the disclosure; and

FIG. 3 illustrates an example embodiment of the system performing a ray casting process while retrieving a template pattern, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository-a storage location where one or more resources are organized, stored and retrieved electronically using a computing device.

As used herein, a “transfer,” a “distribution,” and/or an “allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e. paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

The present disclosure relates generally to detecting unauthorized appropriation attempts using modeling light transport techniques such as ray casting techniques. The solution as described herein uses a user device's camera and sensing hardware to capture the user's physical environment, construct a three-dimensional representation of the environment, and compare extracted ambient details against one or more templates. Ray casting refers to a technique that simulates the projection of virtual rays from a viewpoint (such as a mobile phone camera) into a reconstructed three-dimensional model of the user's physical surroundings. Each ray is traced through the virtual space to detect intersections with ambient objects, allowing the system to extract spatial information such as object locations, surface geometries, and environmental layouts. By capturing this spatial data and projecting it onto an image plane, the system is able to analyze and interpret the physical context in which a transaction is being requested.

There is a growing challenge for detecting unauthorized appropriations that mimic legitimate activity. The unauthorized appropriations are often carried out by malicious individuals. Conventional detection techniques rely on metadata such as IP addresses, device fingerprints, transaction history or the like, which can be manipulated by malicious individuals and fail to react to the user's real-world engagements. These methods do not incorporate direct, real-time insight into the physical environment in which the transaction is taking place. As a result, malicious individuals may initiate unauthorized transactions from locations or devices that appear legitimate from a network perspective but are physically untrustworthy. There is a need for a solution that uses contextual physical verification, performed directly on the user's device, to improve unauthorized appropriation detection accuracy and reduce dependence on centralized systems or reactive mitigation.

What is more, the present disclosure provides a technical solution to a technical problem. As described herein, the technical problem includes the inability of conventional systems to verify real-time physical context of a transaction request. The technical solution presented herein allows for ray casting verification procedures performed on a user device. In particular, the system is an improvement over existing solutions to conventional systems inability to detect physical surroundings of the user, (i) with fewer steps to achieve the solution, thus reducing the amount of computing resources, such as processing resources, storage resources, network resources, and/or the like, that are being used (e.g., avoiding round trips to a centralized engine), (ii) providing a more accurate solution to problem, thus reducing the number of resources required to remedy any errors made due to a less accurate solution (e.g., identifying when a user is not at a known safe merchant location), (iii) removing manual input and waste from the implementation of the solution, thus improving speed and efficiency of the process and conserving computing resources (e.g., eliminating the need for the user to manually respond to security prompts or one-time passcodes by instead automating authentication through environmental verification), (iv) determining an optimal amount of resources that need to be used to implement the solution, thus reducing network traffic and load on existing computing resources (e.g., dynamically assessing transactions based on ray casting procedures). Furthermore, the technical solution described herein uses a rigorous, computerized process to perform specific tasks and/or activities that were not previously performed. In specific implementations, the technical solution bypasses a series of steps previously implemented, thus further conserving computing resources.

In addition, the technical solution described herein is an improvement to computer technology and is directed to non-abstract improvements to the functionality of a computer platform itself. Specifically, the unauthorized appropriation detection system as described herein is a solution to the problem of verifying transaction authenticity based on real-time environmental context. Further, the unauthorized appropriation detection system may be characterized as identifying a specific improvement in computer capabilities and/or network functionalities in response to the unauthorized appropriation detection system's integration to existing devices, software, applications, and/or the like. In this way, the unauthorized appropriation detection system improves the capability of a system to authenticate transactions based on ambient environmental modeling in real time. Further, the unauthorized appropriation detection system improves the functionality of networks in response to reducing the resources consumed by the system (e.g., network resources, computing resources, memory resources, and/or the like).

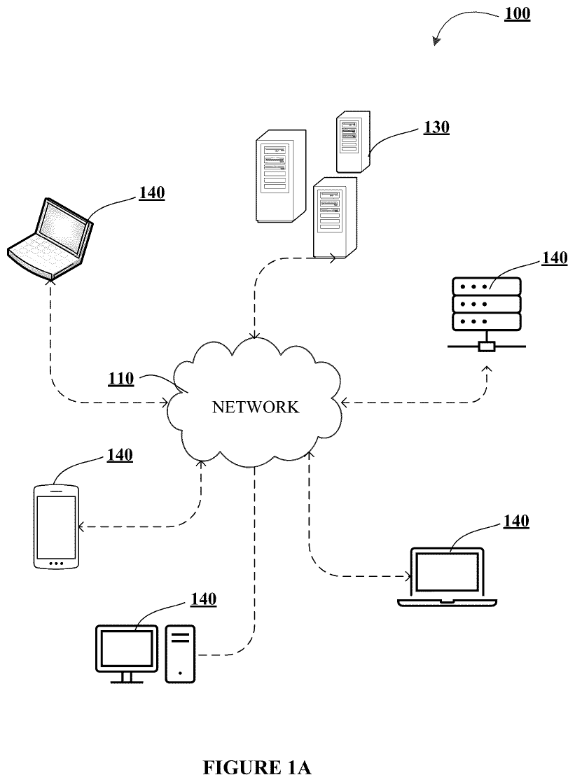

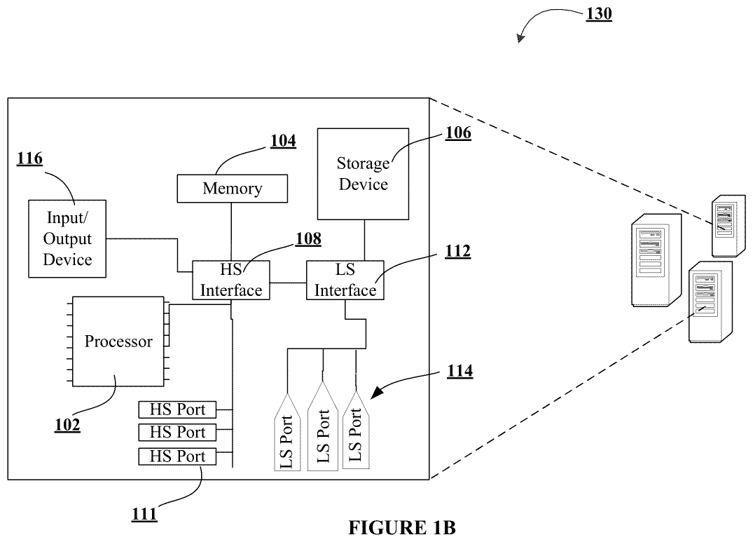

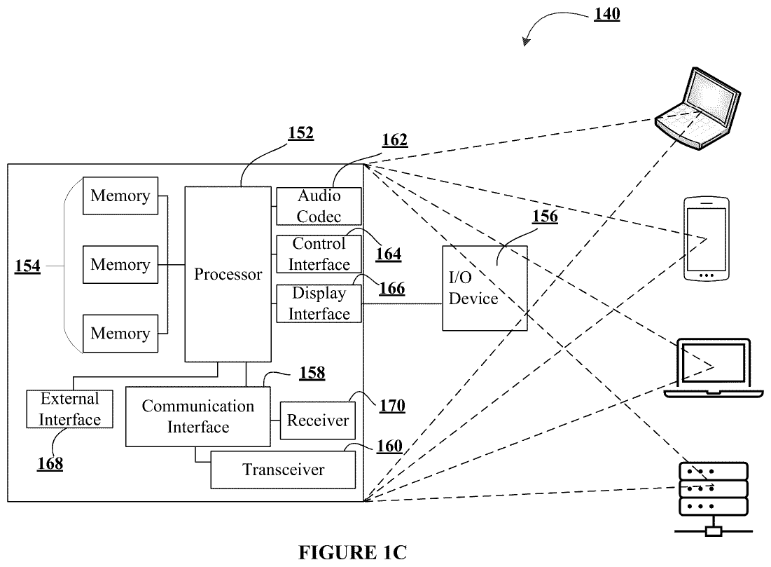

FIGS. 1A-1C illustrate technical components of an exemplary distributed computing environment 100 for detecting unauthorized appropriation attempts using modeling light transport techniques, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server (e.g., system 130). In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, resource distribution devices, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. In some embodiments, the network 110 may include a telecommunication network, local area network (LAN), a wide area network (WAN), and/or a global area network (GAN), such as the Internet. Additionally, or alternatively, the network 110 may be secure and/or unsecure and may also include wireless and/or wired and/or optical interconnection technology. The network 110 may include one or more wired and/or wireless networks. For example, the network 110 may include a cellular network (e.g., a long-term evolution (LTE) network, a code division multiple access (CDMA) network, a 3G network, a 4G network, a 5G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion, or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, storage device 106, a high-speed interface 108 connecting to memory 104, high-speed expansion points 111, and a low-speed interface 112 connecting to a low-speed bus 114, and an input/output (I/O) device 116. The system 130 may also include a high-speed interface 108 connecting to the memory 104, and a low-speed interface 112 connecting to low-speed port 114 and storage device 106. Each of the components 102, 104, 106, 108, 111, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system. The processor 102 may process instructions for execution within the system 130, including instructions stored in the memory 104 and/or on the storage device 106 to display graphical information for a GUI on an external input/output device, such as a display 116 coupled to a high-speed interface 108. In some embodiments, multiple processors, multiple buses, multiple memories, multiple types of memory, and/or the like may be used. Also, multiple systems, same or similar to system 130, may be connected, with each system providing portions of the necessary operations (e.g., as a server bank, a group of blade servers, a multi-processor system, and/or the like). In some embodiments, the system 130 may be managed by an entity, such as a business, a merchant, a financial institution, a card management institution, a software and/or hardware development company, a software and/or hardware testing company, and/or the like. The system 130 may be located at a facility associated with the entity and/or remotely from the facility associated with the entity.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 may store information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 106, or memory on processor 102.

In some embodiments, the system 130 may be configured to access, via the network 110, a number of other computing devices (not shown). In this regard, the system 130 may be configured to access one or more storage devices and/or one or more memory devices associated with each of the other computing devices. In this way, the system 130 may implement dynamic allocation and de-allocation of local memory resources among multiple computing devices in a parallel and/or distributed system. Given a group of computing devices and a collection of interconnected local memory devices, the fragmentation of memory resources is rendered irrelevant by configuring the system 130 to dynamically allocate memory based on availability of memory either locally, or in any of the other computing devices accessible via the network. In effect, the memory may appear to be allocated from a central pool of memory, even though the memory space may be distributed throughout the system. Such a method of dynamically allocating memory provides increased flexibility when the data size changes during the lifetime of an application and allows memory reuse for better utilization of the memory resources when the data sizes are large.

The high-speed interface 108 manages bandwidth-intensive operations for the system 130, while the low-speed interface 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed interface 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router (e.g., through a network adapter).

The system 130 may be implemented in a number of different forms. For example, the system 130 may be implemented as a standard server, or multiple times in a group of such servers. Additionally, the system 130 may also be implemented as part of a rack server system or a personal computer (e.g., laptop computer, desktop computer, tablet computer, mobile telephone, and/or the like). Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 156, 158, 160, 162, 164, 166, 168 and 170, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor 152 may be implemented as a chipset of chips that include separate and multiple analog and digital processors. The processor 152 may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156 (e.g., input/output device 156). The display 156 may be, for example, a Thin-Film-Transistor Liquid Crystal Display (TFT LCD) or an Organic Light Emitting Diode (OLED) display, or other appropriate display technology. An interface of the display may include appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a Single In Line Memory Module (SIMM) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner. In some embodiments, the user may use applications to execute processes described with respect to the process flows described herein. For example, one or more applications may execute the process flows described herein. In some embodiments, one or more applications stored in the system 130 and/or the user input system 140 may interact with one another and may be configured to implement any one or more portions of the various user interfaces and/or process flow described herein.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as GSM voice calls, SMS, EMS, or MMS messaging, CDMA, TDMA, PDC, WCDMA, CDMA2000, GPRS, and/or the like. Such communication may occur, for example, through transceiver 160. Additionally, or alternatively, short-range communication may occur, such as using a Bluetooth, Wi-Fi, near-field communication (NFC), and/or other such transceiver (not shown). Additionally, or alternatively, a Global Positioning System (GPS) receiver module 170 may provide additional navigation-related and/or location-related wireless data to user input system 140, which may be used as appropriate by applications running thereon, and in some embodiments, one or more applications operating on the system 130.

Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed application specific integrated circuits (ASICs), computer hardware, firmware, software, and/or combinations thereof.

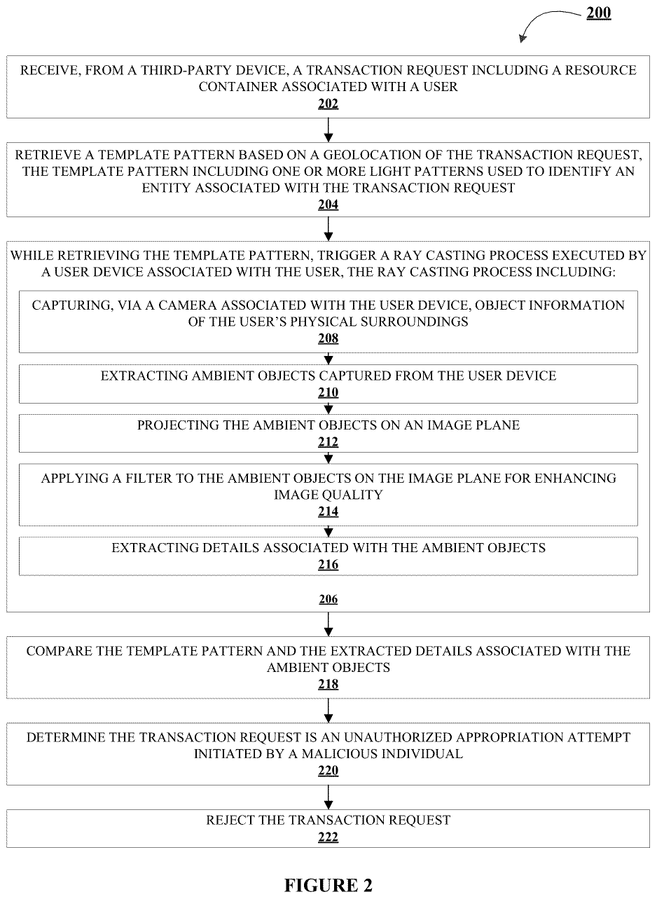

FIG. 2 illustrates a process flow for detecting unauthorized appropriation attempts using modeling light transport techniques, in accordance with an embodiment of the disclosure. The method may be carried out by various components of the distributed computing environment 100 discussed herein (e.g., the system 130, one or more end-point device(s) 140, etc.). An example system may include at least one processing device and at least one non-transitory storage device with computer-readable program code stored thereon and accessible by the at least one processing device, wherein the computer-readable code when executed is configured to carry out the method discussed herein.

In some embodiments, an unauthorized appropriation detection system (e.g., similar to one or more of the systems described herein with respect to FIGS. 1A-1C) may perform one or more of the steps of process flow 200. For example, an unauthorized appropriation detection system (e.g., the system 130 described herein with respect to FIGS. 1A-1C) may perform the steps of process flow 200.

As shown in block 202, the process flow 200 of this embodiment provides a solution that may receive, from a third-party device, a transaction request including a resource container associated with a user. In some embodiments, the transaction request may trigger the unauthorized appropriation detection system. In some embodiments, the transaction request may take variety of forms including, but not limited to, a debit or credit card swipe, a transaction initiation from a user device, using a check for the transaction, or other ways of exchanging value. In this way, the resource container may be an account the user has at a financial institution wherein the user stores resources. For example, the resource container may be a bank account of the user, wherein the user may use a credit or debit card to use the resources in the bank account for purchasing goods or services.

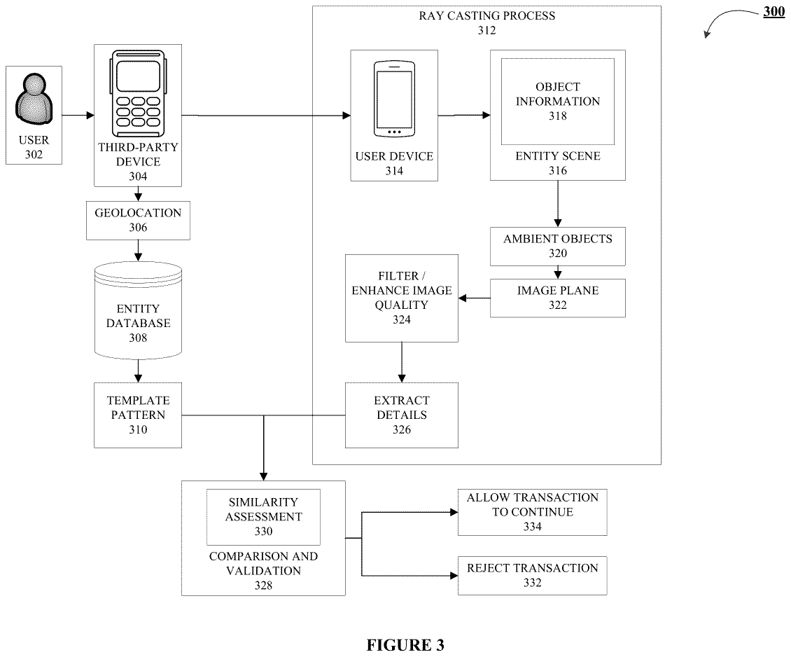

In some embodiments, the third-party device may refer to any external system or endpoint that initiates or facilitates a transaction involving the user's resource container. In some embodiments, the third-party device may be distinct from the user's user device and may operate outside the user's direct control. For example, the third-party device may include retail point of sale terminals, merchant operated mobile readers, online payment gateways, ATMs, e-commerce modules, peer-to-peer payment interfaces, or the like. Additionally, or alternatively, and as shown in FIG. 3, the third-party device 304 may be used by the user 302. In this regard, the third-party device may be responsible for submitting the transaction request to the system and may transmit contextual data, such as the resource container to be accessed, the geolocation or network location of the initiating device, timestamp, and the like.

As shown in block 204, the process flow 200 of this embodiment provides a solution that may retrieve a template pattern based on a geolocation of the transaction request, the template pattern including one or more light patterns used to identify an entity associated with the transaction request. The geolocation may be determined from metadata associated with the third-party device (e.g., stored location data), such as GPS coordinates, IP address geotagging, Wi-Fi triangulation, or other forms of location inference. For example, as shown in FIG. 3, the geolocation 306 may be determined based on the third-party device 304, which may include gathering the geolocation 306 from the third-party device 304. In some embodiments, based on the geolocation data, the system may query a database to obtain the template pattern, which may be a structured representation of expected environmental characteristics at the specific location (e.g., the geolocation). For example, an entity database 308 (as shown in FIG. 3) may be accessed to retrieve the template pattern 310.

In some embodiments, the template pattern may include one or more light patterns, which may include geometric light-field data, illumination sources, shading maps, historical ray transport data, or other data previously captured or generated at the location. In some embodiments, the light patterns may be used to represent a visual or spatial signature associated with the entity (e.g., a merchant, store, ATM, etc.) tied to the transaction request.

In some embodiments, the template pattern may be retrieved from a database associated with the entity (e.g., entity database 308). In this regard, the database associated with the entity may stored template patterns specific to the entity. For example, a retail chain may maintain a database of template patterns (e.g., light patterns) for each of its physical store locations. In this regard, the template patterns may include characteristic lighting patterns, object layouts, surface properties, or the like that are specific to each storefront. The retrieved template pattern may serve as a point of comparison against the real-time data gathered by the user device through ray casting. In this way, the system may verify whether the current environment matches the expected visual context for that transaction.

As shown in block 206, the process flow 200 of this embodiment provides a solution that may, while retrieving the template pattern, trigger a ray casting process executed by a user device associated with the user. In some embodiments, the ray casting process is initiated concurrently or simultaneously as the template pattern is being retrieved. For example, as shown in FIG. 3, while the template pattern 310 is being retrieved, the ray casting process 312 may be initiated. In this way, the transaction request at the third-party device 304 may trigger the ray casting process 312 on the user device 314. In some embodiments, the third-party device 304 may communicate via a network (e.g., network 110 as shown in FIGS. 1A-1C) with the user device 314. In some embodiments, the user device 314 may have components the same or similar as those components as described with respect to end-point device 140 in FIGS. 1A-1C. For example, the user device 314 may have a communication interface 158 that may transmit and receive communications from the third-party device 304. In other embodiments, the third-party device 304 may communicate with another component coupled with the network 110, which may communicate with the user device 314. In this way, the third-party device 304 may communicate, directly or indirectly, to the user device 314 that the transaction request has been received.

Additionally, or alternatively, in some embodiments, the ray casting processing may be executed or initiated on the user device 314, such as a mobile phone, tablet, smart watch, or the like. The ray casting process is launched in real-time and designed to capture and analyze the physical environment surrounding the user at the moment the transaction request takes place. In some embodiments, the user device 314 may be equipped with a camera and depth-sensing hardware (e.g., similar to those components as described with FIGS. 1A-1C). For example, the user device may include LiDAR sensors, time-of-flight sensors, radar, radio waves, or the like that may be used to determine depths.

As shown in block 208, the ray casting process may include capturing, via a camera associated with the user device, object information of the user's physical surroundings. In some embodiments, the ray casting process may acquire an entity scene 316 which may include a visual and spatial representation of the user's current environment. For example, the entity scene 316 may include object information 318 such as structures (e.g., walls, furniture, fixtures), dynamic elements (e.g., people), ambient conditions (e.g., lighting, shadows), and the like.

In some embodiment, the ray casting process may include generating, by the user device, a plurality of virtual rays originating from the user device positioned within a three-dimensional representation of an environment of the user. In some embodiments, the rays may be generated from a simulated origin point corresponding to the user device's current location and orientation in space. The rays may be mathematically projected into a three-dimensional reconstruction of the user's environment, which may be generated dynamically based on the captured image and depth data. In this regard, each ray may represent a vector extending from the user device into the surrounding space (e.g., the user's environment), and the system may calculate whether and where each ray intersects with virtual objects/surfaces in the three-dimensional representation.

As shown in block 210, the ray casting process may include extracting ambient objects captured from the user device. In some embodiments, the ambient objects (e.g., ambient objects 320 in FIG. 3) may include physical elements present in the user's immediate environment which may include, but is not limited to, walls, doors, tables, chairs, shelves, architecture, ceilings, floors, signage, or any stationary or semi-stationary structure that contributes to the spatial signature of the environment. For example, ambient objects 320 collected by the ray casting process may include a counter of a particular store, along with windows and doors, that contribute to the store's unique or particular look (e.g., the spatial signature). Further, the extraction process may include analyzing the visual image data and the underlying three-dimensional reconstruction to identify ambient objects 320, including surfaces, boundaries, or the like. Further, in some embodiments, the extraction process may use computer vision techniques such as edge detection, object segmentation, depth determination, or the like.

In some embodiments, the ray casting process may include tracing each virtual ray through the three-dimensional representation to detect a plurality of intersections with the ambient objects within the environment. In some embodiments, as each ray moves through the virtual space, it is tested for intersections with the geometry of the reconstructed ambient objects. When a ray intersects an object, the system records critical data about the intersection point, such as the exact 3D coordinates, the distance from the ray's origin, the angle of incidence, and the surface normal at the point of contact.

Further, in some embodiments, multi-ray intersection analysis enables the system to map the spatial structure of the environment by aggregating the results of many individual ray-object interactions. Through this process, the system can determine the shape, relative position, orientation, and surface characteristics of the ambient objects surrounding the user. The intersection data forms a foundation for later stages of the analysis, including the construction of an image plane, the application of filtering algorithms, and the comparison with stored template patterns for authentication.

In some embodiments, the ray casting process may include determining surface properties at each of the plurality of intersections. For example, when a virtual ray intersects an object in the 3D space, the system may collect and analyze data at the intersection point to identify key surface characteristics. In some embodiments, the key surface characteristics may include, but are not limited to depth or distance, surface orientation, reflectivity, texture, material type, and the like. The surface properties provide context by simulating the real-world light transport behaviors.

In some embodiments, the ray casting process may include aggregating intersection data to form a spatial map of the environment. The spatial map may be a synthesized representation of the detected surroundings, combing all intersection points, surface properties, material data, and the like into a cohesive model. In some embodiments, the spatial map may be represented as a point cloud, voxel grid, mesh, depth-enhanced image, or the like. In some embodiments, the aggregation allows the system to determine understandings about the scene, including object boundaries, layouts, presence of structures, and the like. For example, the spatial map may be used for comparison purposes with the template patterns to allow the system to identify discrepancies that may be used to reject the transaction request.

As shown in block 212, the ray casting process may include projecting the ambient objects on an image plane. In some embodiments, the image plane 322 may simulate the view that would be captured by a camera or visual sensor positioned at the origin of the ray casting process. Each point in the spatial map (e.g., previously generated through ray-object intersection) corresponds to a surface point in the real world and is mapped onto a pixel or region on the image plane based on its relative position and orientation. This transformation from 3D space to 2D visual representation allows the system to analyze the spatial layout in a format that is compatible with traditional computer vision techniques, such as filtering, pattern recognition, and image enhancement.

In some embodiments, the ray casting process may include generating the image plane 322 based on the aggregated intersection data representing the surface properties of the ambient objects. In some embodiments, the data-driven image plane may encode geometric arrangements of objects and their physical characteristics (e.g., surface properties such as depth, materials, etc.) that may be represented through different maps or gradients (e.g., colors, heatmaps, intensity gradients, etc.). In this regard, the image plane may be a synthesized view of the environment that includes both spatial structure with contextual detail of the user's environment. The spatial map may enhance the system's ability to assess environment authenticity int eh context of a transaction request.

As shown in block 214, the ray casting process may include applying a filter to the ambient objects on the image plane for enhancing image quality (e.g., as shown in block 324 in FIG. 3). In some embodiments, once the ambient environment has been reconstructed and projected onto a two-dimensional plane, various forms of visual noise or distortion may be present due to sensor limitations, lighting conditions, motion blur, environmental complexity, or the like. In some embodiments, the noise may be mitigated which may be improve the clarity and utility of the image plane. For example, the system may apply one or more image processing filters designed to enhance the fidelity of object features and surface boundaries. The filters may operate on the pixel or pixel-group level, adjusting values based on spatial continuity, contrast, and edge definitions.

In some embodiments, applying the filter to the ambient objects on the image plane may include performing a de-noising operation that reduces image artifacts by removing noise while preserving details of the ambient objects. In some embodiments, the goal of the de-noising operation is to ensure that the resulting image plane provides a clean and accurate representation of the user's physical surroundings, such that feature extraction and comparison with template patterns can be performed with greater precision and confidence. By improving image quality at this stage, the system enhances its ability to detect subtle environmental mismatches, reducing false positives and increasing the overall effectiveness of the unauthorized appropriation detection process.

As shown in block 216, the ray casting process may include extracting details associated with the ambient objects. In some embodiments, the extracted details 326 may include spatial and visual attributes (e.g., shape, size, orientation, texture, reflectivity, positioning, etc.). The system may be able to determine context of the scene using the extracted details 326. For example, the extracted details 326 may contextualize the objects in the scene by providing information as to the material of the objects, the light reflectivity of the objects, the light source, and the like.

In some embodiments, the system may generate a notification including an alert interface component configured to notify the user about the transaction request. The notification may appear as a pop-up, push alert, or in-app prompt, and it may include textual, visual, or auditory cues. In some embodiments, the system may transmit the notification to the user device. In this regard, the system may notify the user so that the user is aware of the ongoing transaction request and verification process.

In some embodiments, the notification may further include generating, based on the object information captured from the camera associated with the user device, a prompt requesting the user to position the camera associated with the user device in a specific orientation to match the template pattern. In this regard, prompt may instruct the user to reposition or reorient the camera in a particular direction to align the live view with the stored template pattern. For example, if the template expects a particular landmark object (e.g., such as a sign, a specific view of a room, or unique piece of furniture) to appear in view, the system may request the user to angle the user device accordingly.

In some embodiments, the prompt may further including displaying an overlay image on a graphical user interface associated with the user device configured to prompt the user to orient the camera associated with the user device at a specific object. This overlay acts as a visual alignment aid, showing a translucent version of the expected template view or target object area. The user can then adjust the orientation of the device in real time until their camera feed aligns with the overlay, thus enabling the system to capture a clearer and more relevant view of the environment for authentication.

As shown in block 218, the process flow 200 of this embodiment provides a solution that may compare the template pattern and the extracted details associated with the ambient objects. In some embodiments, the template pattern, which may represent expected environmental and visual characteristics associated with the entity, may serve as a reference model. The extracted details of the ambient objects may be based on the user's environment and may include geometries, object placements, lighting features, material properties, and the like. In this regard, the template pattern 310 and extracted details 326 may be compared and validated 328. In some embodiments, the system may perform pattern matching operations to perform a similarity assessment 330 between the template pattern and extracted details.

In some embodiments, the system may retrieve a customer template pattern including previously captured customer patterns. In some embodiments, the customer template pattern may include previously captured data specific to the user. In some embodiments, the customer template patterns may be stored on the user device 314, in a user specific database, on a cloud-based database, or the like. In some embodiments, the system may compare the customer template pattern and the extracted details associated with the ambient objects. The comparison may include the user's specific template patterns captured during prior visits to the entity. In some embodiments, the comparison may include the customer template pattern, the template pattern, and the extracted details.

As shown in block 220, the process flow 200 of this embodiment provides a solution that may determine the transaction request is an unauthorized appropriation attempt initiated by a malicious individual. The determination may be made by evaluating the degree of mismatch between the extracted details of the user's current environment (e.g., captured via the ray casting process) and one or more predefined template patterns, such as those associated with a legitimate transaction location or the user's historical transaction behavior. If the system detects that the environment surrounding the user device significantly deviates from the expected pattern in terms of spatial configuration, lighting conditions, object presence, or other ambient characteristics, it may infer that the transaction request is likely being made from a malicious individual. Additionally, or alternatively, in some embodiments, the system may factor in contextual metadata such as time of day, frequency of similar requests, and anomalies in device behavior to support this determination.

In some embodiments, the determination that the transaction request is the unauthorized appropriation attempt initiated by the malicious individual is performed locally on the user device 314 prior to the transaction request being transmitted to other stakeholders. Further, in some embodiments, the determination made on the user device 314 (e.g., locally) may be made prior to the transaction request being sent to external devices, systems, servers, or third-party systems (e.g., others involved in the transaction). In some embodiments, the local determination on the user device 314 may reduce network latency, increase security, and the like.

As shown in block 222, the process flow 200 of this embodiment provides a solution that may reject the transaction request (e.g., as shown in block 332). In some embodiments, the rejection may occur either silently (e.g., by blocking the request from being transmitted) or visibly (e.g., by displaying a security alert to the user). In some embodiments, the system may log the rejected request for further analysis, trigger an escalation protocol, or notify associated institutions or user-defined contacts. In this regard, the rejection of the transaction request may cancel the transaction request from proceed to other processing or transaction layers.

In other embodiments, a determination may be made that the transaction request is legitimate and the user 302 is actually the one performing the transaction request. The similar assessment 330 may provide enough similarity between the template pattern 310 and the extracted details 326 of the ray casting process 312. In this regard, the system may allow the transaction to continue 334. For example, the transaction, after being allowed to continue, may be moved to another layer of the transaction process that is off-device (e.g., off the user device 314).

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for detecting unauthorized appropriation attempts using modeling light transport techniques, the system comprising:
a processing device;
a non-transitory storage device containing instructions when executed by the processing device, causes the processing device to perform the steps of:
receive, from a third-party device, a transaction request comprising a resource container associated with a user;
retrieve a template pattern based on a geolocation of the transaction request, the template pattern comprising one or more light patterns used to identify an entity associated with the transaction request;
while retrieving the template pattern, trigger a ray casting process executed by a user device associated with the user, the ray casting process comprising:
capturing, via a camera associated with the user device, object information of the user's physical surroundings;
extracting ambient objects captured from the user device;
projecting the ambient objects on an image plane;
applying a filter to the ambient objects on the image plane for enhancing image quality;
extracting details associated with the ambient objects; and
compare the template pattern and the extracted details associated with the ambient objects;
determine the transaction request is an unauthorized appropriation attempt initiated by a malicious individual; and
reject the transaction request.

2. The system of claim 1, wherein executing the instructions further causes the processing device to:
generate a notification comprising an alert interface component configured to notify the user about the transaction request; and
transmit the notification to the user device.

3. The system of claim 2, wherein the notification further comprises generating, based on the object information captured from the camera associated with the user device, a prompt requesting the user to position the camera associated with the user device in a specific orientation to match the template pattern.

4. The system of claim 3, wherein the prompt further comprises displaying an overlay image on a graphical user interface associated with the user device configured to prompt the user to orient the camera associated with the user device at a specific object.

5. The system of claim 1, wherein the determination that the transaction request is the unauthorized appropriation attempt initiated by the malicious individual is performed locally on the user device prior to the transaction request being transmitted to other stakeholders.

6. The system of claim 1, wherein the template pattern is retrieved from a database associated with the entity.

7. The system of claim 1, wherein executing the instructions further causes the processing device to:
retrieve a customer template pattern comprising previously captured customer patterns; and
compare the customer template pattern and the extracted details associated with the ambient objects.

8. The system of claim 1, wherein the ray casting process comprises:
generating, by the user device, a plurality of virtual rays originating from the user device positioned within a three-dimensional representation of an environment of the user;
tracing each virtual ray through the three-dimensional representation to detect a plurality of intersections with the ambient objects within the environment;
determining surface properties at each of the plurality of intersections;
aggregating intersection data to form a spatial map of the environment; and
generating the image plane based on the aggregated intersection data representing the surface properties of the ambient objects.

9. The system of claim 1, wherein applying the filter to the ambient objects on the image plane comprises performing a de-noising operation that reduces image artifacts by removing noise while preserving details of the ambient objects.

10. A computer program product for detecting unauthorized appropriation attempts using modeling light transport techniques, the computer program product comprising a non-transitory computer-readable medium comprising code causing an apparatus to:
receive, from a third-party device, a transaction request comprising a resource container associated with a user;
retrieve a template pattern based on a geolocation of the transaction request, the template pattern comprising one or more light patterns used to identify an entity associated with the transaction request;
while retrieving the template pattern, trigger a ray casting process executed by a user device associated with the user, the ray casting process comprising:
capturing, via a camera associated with the user device, object information of the user's physical surroundings;
extracting ambient objects captured from the user device;
projecting the ambient objects on an image plane;
applying a filter to the ambient objects on the image plane for enhancing image quality;
extracting details associated with the ambient objects; and
compare the template pattern and the extracted details associated with the ambient objects;
determine the transaction request is an unauthorized appropriation attempt initiated by a malicious individual; and
reject the transaction request.

11. The computer program product of claim 10, wherein the code further causes the apparatus to:
generate a notification comprising an alert interface component configured to notify the user about the transaction request; and
transmit the notification to the user device.

12. The computer program product of claim 11, wherein the notification further comprises generating, based on the object information captured from the camera associated with the user device, a prompt requesting the user to position the camera associated with the user device in a specific orientation to match the template pattern.

13. The computer program product of claim 12, wherein the prompt further comprises displaying an overlay image on a graphical user interface associated with the user device configured to prompt the user to orient the camera associated with the user device at a specific object.

14. The computer program product of claim 10, wherein the determination that the transaction request is the unauthorized appropriation attempt initiated by the malicious individual is performed locally on the user device prior to the transaction request being transmitted to other stakeholders.

15. The computer program product of claim 10, wherein the template pattern is retrieved from a database associated with the entity.

16. The computer program product of claim 10, wherein the code further causes the apparatus to:
retrieve a customer template pattern comprising previously captured customer patterns; and
compare the customer template pattern and the extracted details associated with the ambient objects.

17. The computer program product of claim 10, wherein the ray casting process comprises:
generating, by the user device, a plurality of virtual rays originating from the user device positioned within a three-dimensional representation of an environment of the user;
tracing each virtual ray through the three-dimensional representation to detect a plurality of intersections with the ambient objects within the environment;
determining surface properties at each of the plurality of intersections;
aggregating intersection data to form a spatial map of the environment; and
generating the image plane based on the aggregated intersection data representing the surface properties of the ambient objects.

18. The computer program product of claim 10, wherein applying the filter to the ambient objects on the image plane comprises performing a de-noising operation that reduces image artifacts by removing noise while preserving details of the ambient objects.

19. A method for detecting unauthorized appropriation attempts using modeling light transport techniques, the method comprising:
receiving, from a third-party device, a transaction request comprising a resource container associated with a user;
retrieving a template pattern based on a geolocation of the transaction request, the template pattern comprising one or more light patterns used to identify an entity associated with the transaction request;
while retrieving the template pattern, trigger a ray casting process executed by a user device associated with the user, the ray casting process comprising:
capturing, via a camera associated with the user device, object information of the user's physical surroundings;
extracting ambient objects captured from the user device;
projecting the ambient objects on an image plane;
applying a filter to the ambient objects on the image plane for enhancing image quality;
extracting details associated with the ambient objects; and
comparing the template pattern and the extracted details associated with the ambient objects;
determining the transaction request is an unauthorized appropriation attempt initiated by a malicious individual; and
rejecting the transaction request.

20. The method of claim 19, wherein the method further comprises:
generating a notification comprising an alert interface component configured to notify the user about the transaction request; and
transmitting the notification to the user device.
